(19) United States
(12) Patent Application Publication
(10) Pub. No.: US 2024/0418859 A1
(43) Pub. Date: Dec. 19, 2024

(54) PELAGIC LASER TOMOGRAPHER AND METHOD THEREOF

(71) Applicant: The Regents of the University of California, Oakland, CA (US)

(72) Inventors: Malcolm Dale Stokes, La Jolla, CA (US); David Nadeau, La Jolla, CA (US)

(21) Appl. No.: 18/740,375

(22) Filed: Jun. 11, 2024

Related U.S. Application Data
(60) Provisional application No. 63/508,788, filed on Jun. 16, 2023.

(51) Int. Cl. G01S 17/894; B63C 11/52; G01S 7/481; G01S 7/4863; G01S 17/86

(52) U.S. Cl. CPC G01S 17/894; B63C 11/52; G01S 7/4813; G01S 7/4814; G01S 7/4816; G01S 7/4863; G01S 17/86

(57) ABSTRACT

A tomographic imaging system is disclosed in this disclosure. The system includes a pressure housing extending along a longitudinal axis and having a first end and a second end disposed along the longitudinal axis, an end cap disposed on the first end of the pressure housing, and a cylinder disposed on the second end of the pressure housing. The system also includes one or more cameras disposed in the pressure housing and oriented towards the cylinder, a light source disposed in the cylinder, the light source being configured to project a light beam, a conical reflector disposed close to one end of the cylinder and away from the one or more cameras, wherein the light source faces towards the conical reflector along an optical axis, and a lens disposed on a path between the light source and the conical reflector.

### CROSS-REFERENCE TO RELATED APPLICATION(S)

The present international application claims priority to U.S. Provisional Patent Application No. 63/508,788, filed on Jun. 16, 2023. The entire contents of the above noted provisional application are incorporated by reference as part of the disclosure of this document.

### STATEMENT REGARDING FEDERALLY SPONSORED RESEARCH OR DEVELOPMENT

This invention was made with Government support under grants no. OCE-1924467 and 7018820 awarded by the National Science Foundation. The Government has certain rights in the invention.

### TECHNICAL FIELD

The present disclosure generally relates to pelagic oceanography and more particularly relates to an oceanographic instrument that uses high resolution optical technology and is coupled with data post-processing analysis, to scan 3D content of a water column to detect and quantify 3D distributions of small particles in the water.

### BACKGROUND

Pelagic oceanography is the study of the open ocean, encompassing the water column that is not in close proximity to the bottom or the shore. This field of oceanography is vast and complex, as it deals with the biological, chemical, physical, and geological aspects of the ocean's pelagic zone. The pelagic zone is typically divided into different layers, each with its own unique characteristics and ecosystems. Limnology, on the other hand, is the study of inland waters such as lakes, reservoirs, rivers, streams, wetlands, and groundwater. It is a multidisciplinary field that integrates aspects of biology, chemistry, physics, geology, and ecology to understand the structure, function, and value of inland aquatic ecosystems. Limnologists examine the dynamics of freshwater systems, including their physical properties (e.g., water flow, temperature, and light penetration) and chemical composition (e.g., nutrient levels and the presence of pollutants).

Quantifying and understanding the distribution of suspended particles and their aggregates in pelagic oceanography and limnology presents an ongoing challenge. Achieving sufficient temporal and spatial resolution is essential to grasp the dynamics of these particles. Such particles encompass both biotic elements such as mesoplankton, organic fragments, and fecal pellets and abiotic components, including dust, precipitates, sediments, flocks, and anthropogenic materials. Notably, these particles and their aggregates, commonly referred to as marine snow, constitute a significant portion of the total particulate matter exceeding approximately 200 microns in the ocean. The transport of organic material from the ocean surface to the deep-sea floor is of particular interest. This process is a recognized key factor in controlling the global carbon cycle, thereby playing a critical role in the sequestration of atmospheric carbon dioxide.

### SUMMARY

The present disclosure describes a Pelagic Laser Tomographer (PLT), an advanced oceanographic instrument designed for the examination of water column. The PLT of the present technology employs high-resolution optical technology to perform three-dimensional scans, effectively detecting and quantifying the spatial distribution of small particles within water. The PLT stands out with its data analysis software and due to its small form factor, which overcomes the traditional limitations faced in pelagic research. These limitations include prohibitive costs, data storage issues, inadequate resolution, and mechanical constraints that typically necessitate the use of large, cumbersome equipment. As a result, the PLT of the present technology facilitates more frequent deployment from smaller research vessels, significantly enhancing the study of pelagic ecosystems.

A tomographic imaging system is described in the present disclosure. In some implementations, the tomographic imaging system includes a pressure housing extending along a longitudinal axis and having a first end and a second end disposed along the longitudinal axis, an end cap disposed on the first end of the pressure housing, a cylinder disposed on the second end of the pressure housing, one or more cameras disposed in the pressure housing and oriented towards the cylinder, a light source disposed in the cylinder, the light source being configured to project a light beam, a conical reflector disposed close to one end of the cylinder and away from the one or more cameras, wherein the light source faces towards the conical reflector along an optical axis, and an axicon disposed along a path between the light source and the conical reflector, wherein the light source, the axicon, and the conical reflector are configured to generate a toroidal light sheet oriented normal to the optical axis.

In another general aspect, an optical tomography instrument is described in the present disclosure. The optical tomography instrument includes a lighting module comprising a light source and a conical reflector, wherein the lighting module generates a toroidal light sheet that surrounds the optical tomography instrument and that is oriented normal to an optical axis between the light source and the conical reflector, and an imaging module comprising one or more cameras, the one or more cameras being rotated and tilted such that its focus is coincident with a position of the toroidal light sheet, wherein the lighting module and the imaging module are disposed in a closed shell of the optical tomography instrument.

In another general aspect, a method of operating a tomographic imaging system is described in this disclosure. The method of operating the tomographic imaging system includes configuring a lighting module and an imaging module of the tomographic imaging system, disposing the tomographic imaging system into water and dragging the tomographic imaging system along a desired underwater trajectory, generating, by the lighting module, a toroidal light sheet surrounding the tomographic imaging system, and recording, by one or more cameras of the imaging module and on a two dimensional image, particles and/or particle aggregates suspended in the water.

### BRIEF DESCRIPTION OF THE DRAWINGS

FIG. 1 illustrates a schematic view of a PLT including primary components in accordance with various embodiments of the present technology.

FIG. 2 illustrates a perspective view of imaging components included in the PLT, including imager, relay doublet, image intensifier, and objective lens, in accordance with various embodiments of the present technology.

FIG. 3A shows a primary objective lens and a reflected virtual objective lens disposed in an acrylic cylinder of the PLT, in accordance with various embodiments of the present technology.

FIG. 3B shows an example contour plot of laser light sheet thickness, in accordance with various embodiments of the present technology.

FIG. 4 shows an image of the PLT being mounted on a support cage, in accordance with various embodiments of the present technology.

FIG. 5 shows a PLT estimation of suspended particulates (equivalent spherical diameter) in a 1500 L test tank (top) and a manual count of suspended particulates measured using an automated fluorescence microscope from a water aliquot (bottom), in accordance with various embodiments of the present technology.

FIG. 6 shows a section of a cast volumetric test target illuminated by a PLT light sheet, in accordance with various embodiments of the present technology.

FIG. 7 shows a simulation of fluid flow field surrounding the PLT at 0.5 m/s, in accordance with various embodiments of the present technology.

FIG. 8 shows a 3D rendering from data collected during a PLT profile through a kelp forest tank at the Birch Aquarium, in accordance with various embodiments of the present technology.

FIG. 9 shows a zoomed in view of a section of the 3D rendering from FIG. 8, showing portion of the 3D model from the Birch Aquarium kelp forest tank, in accordance with various embodiments of the present technology.

FIG. 10 shows data collected from a stationary PLT deployment which was 8 meter depth off the SIO Pier, in accordance with various embodiments of the present technology.

FIG. 11 shows rendered 3D PLT data and coincident CTD data collected with the PLT, the data being samples at 30 Hz from the surface through 10 meter depth offshore San Diego, in accordance with various embodiments of the present technology.

FIG. 12 shows a pelagic red crab image generated by the PLT and with approximately 2 cm carapace, in accordance with various embodiments of the present technology.

FIG. 13 shows particle density data, particle number concentration size spectrogram and nearest neighbor statistical analysis data rendered from 90 meter depth cast offshore San Diego using the PLT, in accordance with various embodiments of the present technology.

FIG. 14 is a flow chart illustrating a method of operating a tomographic imaging system in accordance with various embodiments of the present technology.

### DETAILED DESCRIPTION

Organic material transport is a key factor controlling the global carbon cycle and therefore a critical process influencing carbon dioxide sequestration. The settling of organic and inorganic particulates and aggregates from the surface waters acts as a “biological pump” dependent upon the sinking velocity and remineralization rates of the particulates. The particles including the elements within are constantly recycled through oceans and lakes mediated by a variety of physical and biogeochemical processes. The size and density distributions of particles is a key property of aquatic systems, affecting the transmission of light, controls trophic interactions, and the downward transport of nutrients by sedimentation. To accurately quantify the spatial and size distribution of these particulates requires instrumentation with sampling volumes large enough to distinguish particle patch heterogeneity and to capture the relatively rare, large aggregates as well as having a resolution fine enough to quantify small individual particles.

Various oceanography instruments have been developed to either optically or acoustically estimate particle size and abundance spectra in pelagic waters. Active acoustic techniques, for example, using single beam, split, multibeam, and with single and multiple frequencies and other custom configurations of transponders, have been used for decades to study larger sized (e.g., larger than 1 mm) zoo and ichthyoplankton populations. Some large and complex, combined optical/acoustic systems have been developed, including BIOMAPPER, OASIS and others. The acoustic systems described herein are capable of operating over extended distances and can accommodate substantial sample volumes due to the nature of the frequencies employed. However, they do not match the precision of optical systems and thus fall outside the purview of the technological advancements addressed in this patent application.

Since the 1950s, the disparity in size between particles and light wavelengths has indicated that in situ optical sensing could potentially bypass the laborious process of microscopic sampling, which hampers the extensive analysis of particle distributions. Furthermore, remote sensing methods, such as satellite imagery, are essential for estimating particle size distributions in surface waters. These techniques play a pivotal role in comprehending wide-ranging phenomena, from the relative abundance of species to the mechanisms of carbon export.

At much smaller scales than satellite observations, optical plankton counters configured for remote and towed platforms offer the potential to provide both continuous and real-time information on the abundance of and size frequency distribution of particles in open ocean and lake environments. These systems were initially intended to complement sample information obtained in more traditional net sampling, and potentially to provide taxonomic identification through coupling to automated and semi-automated image analysis systems. Optical plankton counters have aided identification of meso and macrozooplankton and historical samples from the California Cooperature Fisheries Investigation (CalCOFI) program, in identifying vertical behaviors of copepods in the North Atlantic, and in lake systems for identifying plankton size distributions. Moreover, time series estimations of plankton size spectra have provided information used to estimate growth and mortality. The ability to distinguish particle sizes and to estimate particle abundance has also been used in systems with high detritus abundance.

However, the three-dimensional (3D) mapping of particle distributions presents significant challenges when employing conventional methodologies. For example, optical plankton counters have limitations when they are predicated based on the measurement of the cross-sectional area of particles traversing distinct light beams. These limitations are particularly evident in scenarios where multiple particles concurrently exist on a path of a beam, a situation that frequently arises at elevated plankton densities. Furthermore, the diminutive dimensions of phytoplankton and microbial particles motivate the development of various techniques, among which flow cytometry has been prominently utilized.

Conventional technologies in the realm of in situ particulate analysis typically utilize small sample volumes. These are primarily designed for capturing detailed images of individual particles, which are subsequently utilized for automated identification processes. This includes the highly successful Video Plankton Recorder (VPR) underwater microscope system and its varied deployment iterations, ZooVis, ISIIS and whole suite of laser and holographic particle counters. These devices are particularly adept at particle discrimination and mesoplankton identification, benefiting greatly from the enhancements in computer-aided analysis. Despite their proficiency in these areas, they do not provide a same level of particle spatial distribution and abundance data as instruments that sample across larger image volumes.

The PLT disclosed in the present disclosure is an advanced optical system designed to analyze and quantify particulate matter within a water sample volume. Unlike traditional optical plankton counters that focus on minuscule volumes for individual particle identification, the PLT is engineered to scan and evaluate substantially larger volumes of water. This capability allows for the assessment of particulate distribution across both the breadth and depth of expansive water columns. By aggregating data from multiple water columns, the PLT of the present technology facilitates a comprehensive spatial analysis of particulate distributions over a broad region. One of the critical advantages of the PLT is its compactness and lightweight construction, which significantly enhances its deployability. These attributes distinguishes the PLT from conventional technologies which have an optical system and an imaging system that are separately disposed, and enable the PLT to be rapidly and conveniently utilized in a diverse array of locations, surpassing the practical deployment limitations of many existing, bulkier instruments.

There are other oceanography instruments that are commercially available such as the Hydroptix underwater video/vision profiler (UVP) and the Optical Serial Section Tomography (OSST), Planar laser imaging fluorometer (PILF)/FIDO-Φ instruments. These devices share an objective of delineating size density and spatial particle distribution within slender segments of the water column via vertical depth profiling. For example, UVP5 is a monochromatic (red LED) imaging system that weighs approximately 30 kg and is winch-deployed either alone or mounted within a CTD rosette and controlled by a shipboard computer. It records images of a small 396 cm² (22×18 cm) illuminated surface at up to 10 Hz intervals (20 cm vertical spacing) with a 1280×1024 pixel imager. The collected images can be analyzed real time to provide particle counts or selected images can be post-processed for automated plankton identification using Zooprocess software. The commercially available UVP and similar instruments have been deployed worldwide to study the size frequency distribution of particulates and mesoplankton larger than 200 microns. Another example is UVP6-LP design which has been created smaller in size than the UVP5, having a 5 MPix sensor, imaging a 18×15 cm area and being designed for low power operation at reduced sampling rate (maximum 1.3 fps and relatively long 53 ms illuminated frame interval) on autonomous floats (i.e., Argo), gliders and moorings. A similar UVP6-HF, high-frequency version is available with a higher sample rate (up to 20 Hz) with greater power requirements has also been reported. The UVP6-LP has been extensively tested alongside the UVP5 to ensure data fidelity and quality control, and has a streamlined workflow optimized for long deployments including satellite monitoring of UVP data generated from a remote platform and post-recovery taxonomic analysis of saved data frames.

Further, the 2D planar fluorescent imaging system OSST and subsequent refinement as the PILF/FIDO-Φ free-falling instrument (to minimize the effects of ship heave induced fluid motion on the suspended imager) was configured to record images of a ˜1000 cm² illuminated surface beneath the instrument every ˜2 second at ˜20 cm intervals. The PILF instrument used a monochromatic laser source and narrowband filtering on the image sensor to resolve fluorescent backscatter from particulates with a resolution of ˜300 microns. A large (>1000 kg) free-vehicle was used to study fluorescent particle size abundance spectra in the upper 90 m of the water column near San Diego and in a stereoscopic mode (with 625 cm² image area) with PIV capabilities.

Nevertheless, the PLT of the present technology distinguishes itself by integrating an optical system and an imaging system with a body of the PLT, being markedly smaller and lighter, and offering higher-resolution imaging over a wider field of view. In comparison, the UVP5, a very successful instrument in this field, costs over $100,000. This highlights the economic importance of introducing the PLT of the present technology to the market.

In addition, the present technology introduce the PLT that is designed to effectively characterize the position and density of suspended particulates within a substantial area of approximately 3000 cm². The field of view of the PLT is adjustable and capable of capturing a series of spatially contiguous slices at a high temporal resolution of up to 30 Hz. This innovative tool boasts a significant reduction in size, weight, and cost compared to most prior instruments in the field. Furthermore, the present technology leverages 3D tomographic algorithms coupled with high-performance computing techniques. These enhancements facilitate the accurate reconstruction of the position and size of detected particles into a comprehensive 3D volume. The reconstructed data can then be subjected to detailed statistical analysis and visual representation, thereby providing a more profound insight into the particulate distribution within a surveyed area of the water.

### Overview of the Pelagic Laser Tomographer

The present technology relates to a PLT device and method for imaging and analyzing particles and particle aggregates in water environments. The PLT operates through employing a scanning mechanism that generates consecutive, thin volumetric segments by traversing a 0.35 meter radius horizontal plane within the aquatic medium. This scanning process is continuous and is executed as the PLT descends through the water or as water moves relative to the PLT device when affixed to a stationary or mobile platform. The resultant scans yield a 3D dataset representing the in situ distribution and concentration of pelagic particles, which is subsequently reconstructed into a 3D representation through specialized tomographic software for visualization and analytical purposes. In the present technology, the PLT can be deployed via manual launch from small watercraft or integration into comprehensive oceanographic instrument arrays, such as Conductivity, Temperature, and Depth (CTD) sensors or water sampling systems. The fully assembled PLT measures approximately 60 centimeters in length and has a mass of around 6 kilograms.

In the present technology, the inter-slice distance of the tomographic output is contingent upon the PLT's velocity through the water column and the imaging frame rate. Reduced velocities, such as 0.2 meters per second, permit finer slice intervals, enhancing spatial resolution and reducing image distortion. At a 2.5 millimeter light sheet thickness and a 30 Hertz capture rate, the PLT can record 5.5 meters of overlapping image frames per minute, with the capability to store in excess of 1000 meters of image data on a 256 gigabyte memory card. Conversely, increased velocities or reduced frame rates result in wider gaps between slices. In the present technology, the PLT's brief shutter duration of 0.6 milliseconds mitigates image blur during a rapid movement. Additionally, frame rate selection enables the optimization of spatial resolution over a shorter distance or duration at higher rates, or the extension of operational time or coverage at the expense of resolution due to longer intervals between the frames.

### Pelagic Laser Tomographer Hardware

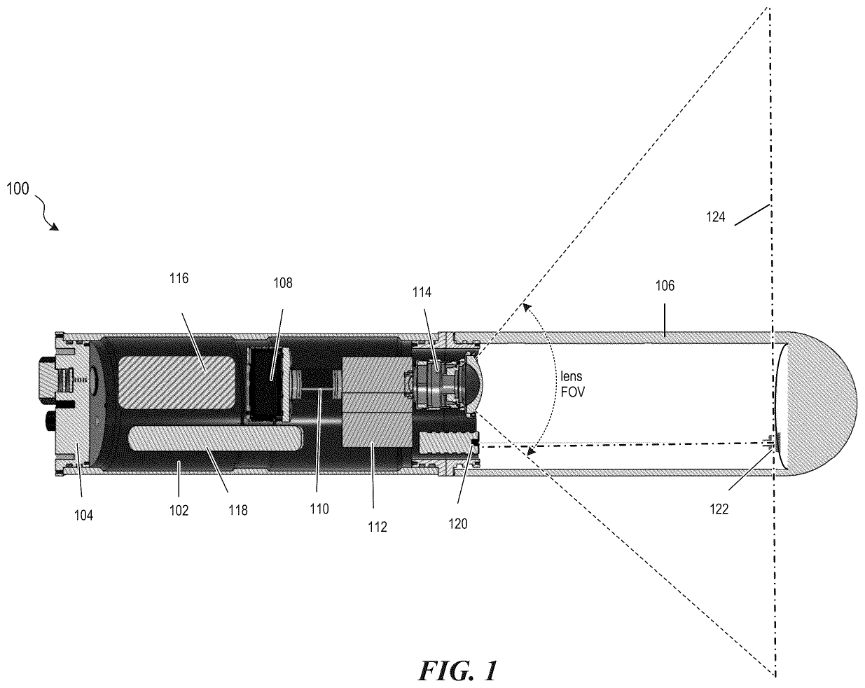

FIG. 1 illustrates a schematic view of a PLT 100 including primary components in accordance with various embodiments of the present technology. The PLT 100 is a tomographic imaging system that generates a thin sheet of optical light (e.g., laser light) and captures images of the light scattered by particles or particle aggregates in the water column. In this example, the PLT 100 is primarily designed using off-the-shelf components, along with custom-fabricated mechanical hardware and custom control/data management software.

As shown in FIG. 1, the PLT 100 comprises a pressure housing 102 that encloses most of the components and protects them from the high-pressure environment. As shown in FIG. 1, the pressure housing 102 has an end cap 104 that is removable for accessing the components inside. The pressure housing 102 is attached to a cylinder 106 that extends the length of the device and provides structural support. Here, the pressure housing 102 can be made of materials comprising aluminum, titanium, stainless steel, polycarbonate, acrylic, polyethylene, and/or a combination thereof. The cylinder 106 also has a transparent window that allows the camera 108 to view, through imaging components such as the image intensifier 112 and the objective lens 114, the light sheet 124 and the illuminated objects. In this example, the cylinder 106 is transparent and can be made of polymethyl methacrylate (PMMA). As shown in FIG. 1, the image sensor/camera 108 is mounted inside the pressure housing 102 and is connected to the relay optics 110 that magnifies and focuses the image onto the camera 108. In some other examples, the PLT 100 can includes multiple cameras 108. The image sensor/camera 108 is a high-speed digital camera that records the images of the light sheet 124 and the objects within it. The relay optics 110 is a lens system that transfers the image from the image intensifier 112 to the camera 108. The image intensifier 112 is a device that amplifies the light signal from the light sheet 124 and reduces the noise and background light. As shown in FIG. 1, the objective lens 114 is attached to the pressure housing 102 by a flange and a seal. Particularly, the image intensifier 112 is mounted on the objective lens 114 that focuses the light sheet onto the image intensifier 112.

In this example, the microcontroller/memory sensor electronics 116 controls the operation of the camera 108, the image intensifier 112, the objective lens 114, and a light source (laser source) 120. The microcontroller/memory sensor electronics 116 is powered by a battery 118 that is also housed inside the pressure housing 102. In addition, the laser source 120 provides a pulsed laser that generates the light sheet 124 and is also housed inside the pressure housing 102. As shown in FIG. 1, the laser source 120 is aligned to a light sheet optics 122 that shapes and directs the light sheet 124 through the window of the cylinder 106.

In this example, the light sheet 124 is a thin plane of light that is perpendicular to the optical axis of the laser source 120 and the light sheet optics 122. In some examples, the light sheet 124 may have a thickness ranging from 2 mm to 2.5 mm. In some other examples, the light sheet 124 may have a thickness up to 10 mm. Here, the light sheet 124 illuminates a cross section of the water column and the objects (e.g., particles and particle aggregates) within it. The camera 108 captures the images of the light sheet 124 and the scattered light from the objects at a high frame rate and synchronizes with pulsed laser light generated from the laser source 120. In particular, the camera 108 can rotate and tilt such that its focus is coincident with a position of the light sheet124. Those slices two dimensional light sheet images are stored in a memory card or transmitted to a surface computer for further analysis.

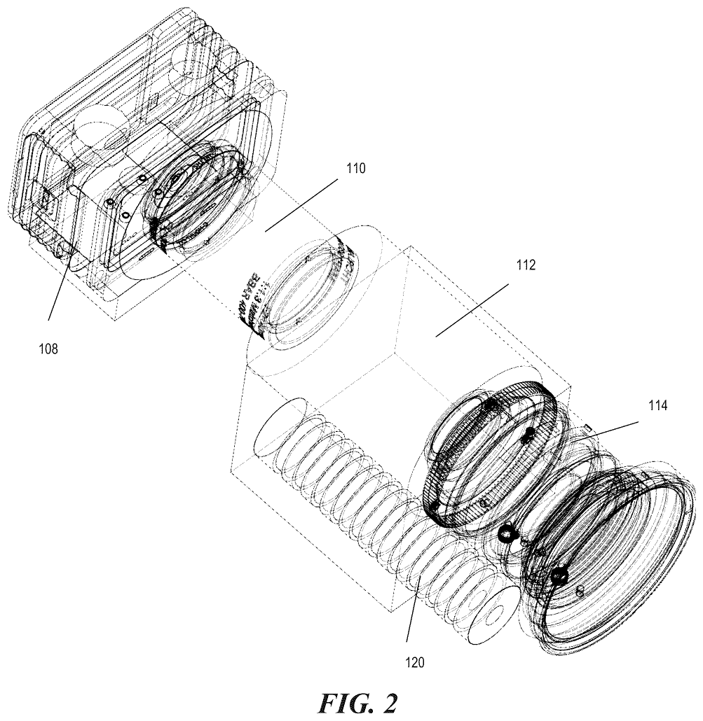

In some implementations, a CMOS image sensor 208 (e.g., a 15 Mpixel SONY Exmor-RS image sensor with a 1.55 μm pixel size) and an image processor (e.g., Ambarella A9SE7 Dual Core Cortex ARM A9 SoC with 4 k image processor), recording at up to 30 Hz taken from a modified commercial camera (SONY RX1), can be incorporated in the PLT 100 to record tomographic image slices, as illustrated in FIG. 2. Each frame has 3840×2160 pixels per image, spanning an approximately 300-degree field of view as the camera is aimed perpendicular to the frame illumination. The frame illumination is provided by a 532 nm laser diode module 220 projecting a gaussian beam through an axicon (e.g., axicon made by Thorlabs) and conical reflector (e.g., conical reflector made by Edmunds Optics) to create a 2 mm thick toroidal light sheet oriented normal to the optical axis of the imager and pulsed in synchrony with the image shutter. Scattered light from particles within the light sheet 124 is focused onto the objective end of an image intensifier tube 212 (e.g., NVision LRS2) by a 6 mm, f 1.8 lens 214 (e.g., lens made by Kowa), filtered by a 532 nm narrow bandpass filter (e.g., filter made by Edmunds Optics) to eliminate background illumination and amplified to increase the weak scattered signal. In this example, the intensifier tube 212 has a working gain of up to 3000× and a resolution greater than the Exmor-RS CMOS image sensor 208 so that no resolution is lost in the amplification stage. Here, the inclusion of the image intensifier 212 allows the image recording sensor (e.g., the CMOS image sensor 208) to function at a lower gain setting to decrease photon shot noise on the sensor. It also allows the PLT 100 to record with shorter shutter speeds (e.g., 0.6 ms) to reduce image smearing due to instrument motion. As shown in FIG. 2, the image intensifier tube 212 is attached via a relay lens doublet 210 (e.g., relay lens doublet made by Thorlabs) for coupling to the CMOS imaging sensor 208. In this example, using an imaging engine from the image sensor 208 (e.g., Sony camera) allows the PLT 100 to use the gain, exposure, memory and power functions of an imaging system which has been optimized for efficient low-power operation in a compact package.

In the present technology, the PLT 100 can incorporate a group of sensors for precise orientation and depth logging. For example, orientation can be captured using an integrated circuit (e.g., LSM9DS1), which includes a gyroscope, accelerometer, and compass, while depth can be measured by a pressure sensor (e.g., MS5837-30BA). These measurements can be taken at a frequency of 5 Hz and are time-stamped to correlate with the imager data, facilitating correction of camera rotation and tilt in post-processing. In addition, the PLT 100 can utilize a highly accurate, temperature-compensated real-time clock (RTC, e.g., Maxim DS3231) to ensure data synchronization with an error margin of only 0.007 seconds per hour, which is negligible considering the maximum frame rate of 30 frames per second (fps). The PLT 100 can also log additional operational data such as battery voltage, internal and external temperatures (e.g., via a TSYS01 sensor), and system state metadata.

In the present technology, data storage can be handled by a removable SD card embedded in the PLT 100, while power can be supplied by a regulated lithium-ion battery pack (e.g., 22,000 mAh, Voltaic) which is capable of sustaining over 20 hours of operation. Operational longevity is dependent on available memory and the chosen sampling rate. Further, the PLT 100 can be controlled by a microcontroller (e.g., ATmega32u4), which oversees data logging, image capture, laser and intensifier operations, power management, and frame capture. In particular, the microcontroller can be programmed with custom firmware that allows for post-deployment data retrieval and system adjustments via a USB connection to an external laptop computer.

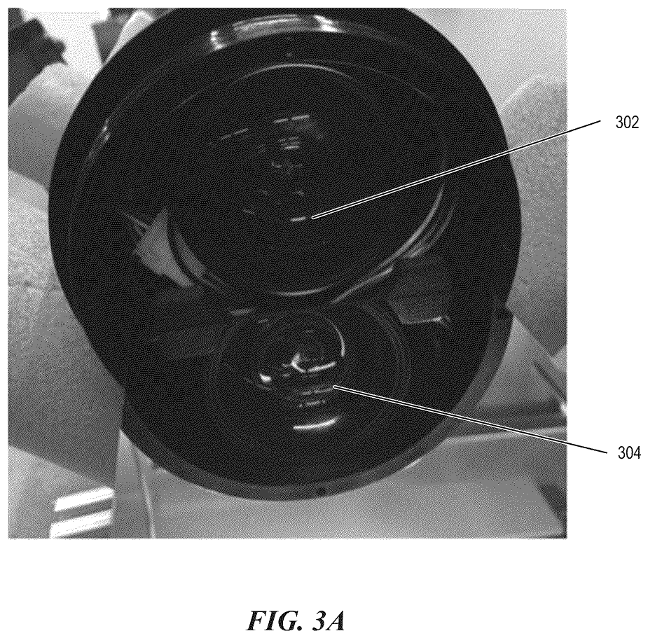

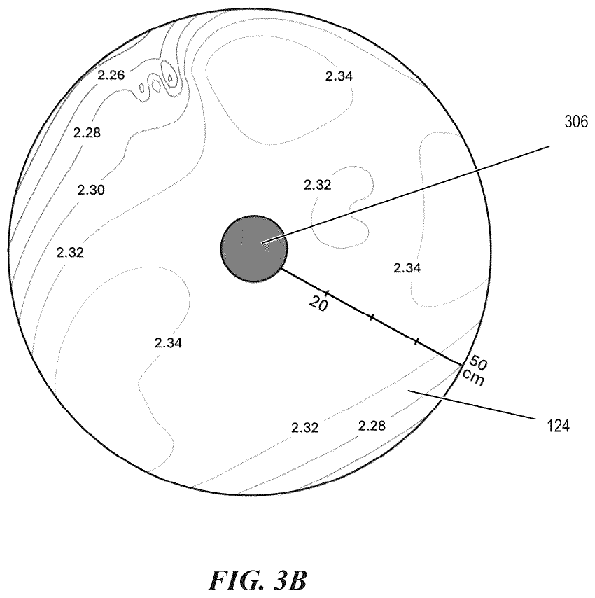

The disclosed embodiments encompass an improved PLT design that incorporates a first-surface mirror strategically placed within the optical path inside the cylinder 106 of the PLT 100, which is normally not subject to analysis. For example, FIG. 3A shows a primary objective lens 302 and a reflected virtual objective lens 304 that are disposed in the cylinder 106. The reflected virtual objective lens 304 can perform as a mirror and is oriented orthogonally to the primary objective lens 302, enabling it to capture a reflective view of a segment of the primary imaging plane as depicted in FIG. 1. This configuration introduces an additional image data channel. For example, by substituting the 532 nm laser diode module 220 with a 405 nm laser source and applying suitable filters to the reflected image, the PLT 100 is capable of detecting specific fluorescence emissions, such as the 695 nm emission from Chlorophyll A. The integration of these enhancements on the PLT 100 not only augments its fluorescence detection capabilities (e.g., similar to features found in PILF/FIDO-¢ systems) but also significantly improves the compactness and versatility of PLT 100.

In some examples, the light sheet 124 generated by PLT 100 may have a variety of thickness, e.g., ranging from 2 mm to 2.5 mm. For example, FIG. 3B shows an example contour plot of laser light sheet thickness within 50 cm radius of the PLT 100 central axis. Here, the light sheet 124 has a mean thickness around 2.3 mm. The center dark circle 306 outlines the perimeter of the PLT cylinder 106. In some other example, the light sheet 124 generated by PLT 100 may have a thickness ranging from 1 mm to 5 mm.

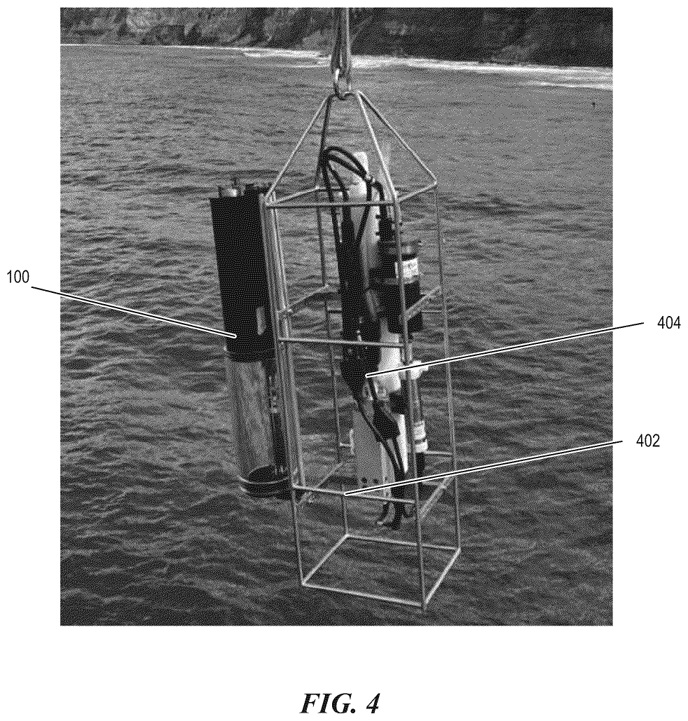

In the present technology, the PLT 100 can be protected within an off-the-shelf, O-ring sealed pressure-resistant housing (e.g., housing made by Blue Robotics, with 101 mm diameter) which limits its operational depth to 400 meters. However, a thicker-walled aluminum or titanium tube can also be adopted for greater depth ranges. In this example, system controls can be accessed through ports in the housing end cap 104 and allow USB access for data downloading, PLT control programming, as well as ports for battery charging and downloading image data. In addition, a vacuum port can be presented on the PLT 100 to allow testing of the O-ring seal integrity before deployment. As shown in FIG. 1, the cylindrical acrylic imaging port (e.g., cylinder 106, 30 cm long, 12 cm diameter, and 2 cm wall thickness) can be attached to the anterior end of the pressure housing 102 using an O-ring sealed flange and houses the laser sheet optics 122 and provides a 360-degree free optical pathway for imaging the surrounding water. In practice, an approximately 60 degree wedge of the toroidal imaging plane can be masked from analysis because the laser optics are in the field of view, and if the PLT 100 is mounted against another structure (e.g., the support cage 402 of FIG. 4) the region which obstructs the water flow and view field are also eliminated from analysis. Moreover, the PLT 100 can include one or more image shutters (not shown). The one or more image shutters can be coupled with the camera 108 or objective lens 114, and configured to synchronize operation of the camera 108 with the light beam pulsed from the light source 120.

In the present technology, the PLT 100 can be designed for multiple deployment methods to suit various operational needs and scenarios. For example, one of the simplest methods to deploy the PLT 100 is by utilizing gravity. This method is straightforward and efficient, requiring minimal equipment. The PLT 100 can be simply released from the edge of a vessel or platform and allowed to descend into the water. The PLT 100 can be designed to be neutrally buoyant or slightly weighted, ensuring that it sinks at a controlled rate without the need for additional propulsion. This method is particularly useful in calm waters and when precision in placement is not the primary concern.

In some examples, and especially in turbulent conditions or when it is necessary to position the PLT 100 at a specific depth, mounting the PLT 100 to a support cage is an ideal solution. For example, as shown in FIG. 4, the PLT 100 can be mounted on a support cage 402. The support cage 402 acts as a protective framework that can be lowered into the water at a predetermined depth. This method allows for the PLT 100 to be securely positioned and retrieved with ease. The support cage 402 can be equipped with additional instruments or tools as required by the mission parameters. For example, a Seabird SBE 19-03 CTD rosette 404, used to measure conductivity, temperature, and depth, and provide validation and supplement sensors, can be equipped with the support cage 402 as shown in FIG. 4.

In some other examples and when mobility and adaptability are important, securing the PLT 100 on a mobile platform is a preferred deployment method. This could involve attaching the PLT 100 to an underwater vehicle, such as a remotely operated vehicle (ROV) or an autonomous underwater vehicle (AUV). By doing so, the PLT can be transported to specific locations, and its sensors can be used to collect data while on the move. This method provides the greatest level of control over the PLT 100's position and movement, allowing for dynamic monitoring of various environments.

### Pelagic Laser Tomographer Control System and Software

In the present technology, microcontroller of the PLT 100 (e.g., the microcontroller/memory sensor electronics 116 shown on FIG. 1) can be operated using custom software written in C++ and uploaded into the microcontroller using an external computer. The control software provides a complete text-based user interface with integrated help system and internal diagnostics to check status of the instrument, program it's functionality for deployment and download collected sensor and image data. In particular, the interface of the PLT 100 can be operated with an Apple, Windows or Linux based computer. PLT image data appears as a separate mass storage drive on the control computer. To ensure optimal performance of the imaging sensor, adjustments to settings such as gain and shutter interval can be precisely made through the use of the dedicated manufacturer control software.

### Pelagic Laser Tomographer Data Processing

In the present technology, after deployment of the PLT 100, data and raw format images can be downloaded for error checking, analysis and visualization purposes. Specifically, custom software (utilizing Matlab as well as open-source code using the OpenCV image processing library) can be utilized to perform analysis and visualization in a semi-automated workflow. This workflow includes reformatting, denoising, structural image masking and clustering to compute final statistics correlated with depth and other sensor data to create a principal tabular data product that shows particulate sizes, densities, spatial clustering, and other attributes, as they vary with depth at the time and GPS location of each PLT profile. The visualizations shown of the PLT example datasets herein can be created using the interactive ParaView application built atop the Visualization Toolkit (VTK) or using the graphic processing functions of Matlab on the tabulated PLT data. ParaView and VTK are both open source and extensible to support customized visualization techniques. In this example, the PLT workflow software is designed to operate seamlessly on both PCs and Macs, supporting a variety of operating systems including Windows, Linux, and macOS. This cross-platform compatibility ensures that users can efficiently manage their workflows regardless of the operating system environment they are working within.

In this disclosure, the raw image analysis workflow can be described as below:
1) Convert to grayscale. The color SONY sensor's green channel can be used to create a grayscale image, discarding red and blue channels due to the Bayer mask's pixel density. In addition, the recorded image from the intensifier can be shaded green from the phosphor of the intensifier amplification tube.
2) Median filter. Image sensor noise can be present even at low gain and leads to single-pixel speckles or “salt and pepper” noise. Fortunately, at the shutter speeds and gain settings of the camera and high-gain amplification from the intensifier stage, the laser illumination makes the particulate ‘dots’ large and bright compared to any single-pixel noise. A median filter (e.g., 3 pixels in width) can be adopted to remove any potential noise and makes thresholding yield cleaner results.
3) Adaptive threshold. This step can be employed to convert grayscale pixels to black or white, depending on whether they are above or below a variable threshold. While simple thresholding uses a single fixed value, adaptive thresholding uses a value based upon the mean of the set of nearby values within a window around the pixel. Adaptive thresholding is used here because raw images captured by PLT include ambient light that varies with depth and surface conditions. Ambient light may also vary across an individual image because of the wide-angle lens used for slice capture and the resulting different viewing directions for different parts of the image. In this example, the threshold can be adaptive, with a 31-pixel window and a −9 bias, to account for varying ambient light conditions.
4) Dilate and erode. This step smooths jagged edges and connects adjacent shapes, without altering the size of particulate dots, by using a single dilate-erode pass. A pair of dilate and erode operations help to fill in jagged borders around particulate dots or other shapes. This also compensates for any thresholding jitter where pixels just barely pass or don't pass a threshold. Dilate and erode can also connect adjacent groups of dots that are part of the edge of a continuous shape, such as a piece of kelp or a fish. Once connected, the smoothed edge is more easily rejected during contour filtering. By using a pair of dilate and erode passes, the size of particulate dots doesn't change, the edges just become smoother. In this step, a single dilate-erode pair can be done.
5) Mask. In this step, portions of the image that are irrelevant or problematic, such as the PLT cylinder bottom, laser optics, instrument mounting, and areas with potential internal reflections, are masked out. Particularly, the grayscale image can be masked to remove portions of the image that cannot contain data or have potentially problematic data. For instance, masking removes the camera's view of the PLT cylinder bottom in the center of each image, along with portions of each image containing laser optics and instrument mounting. Masking can also remove portions of each image prone to internal reflections in shallow water that are caused by sunlight reflecting through the thick portion of the cylinder's clear acrylic sidewalls.
6) Contour. The contouring step identifies bright regions surrounded by dark pixels. A particulate dot or the edge of a piece of kelp or other potential target all create contours. Each contour has a series of (x, y) pixel coordinates for a path around the edge of the bright region. This defines a 2D shape in the image slice, and each particulate dot or other target has its own contour.
7) Contour filter. The set of contours pulled from an image can be further filtered to remove contours that are unreasonably large, such as those for the edge of a piece of kelp or fish or extreme lighting artifacts, like sunlight glints when the PLT 100 is at or near the water surface. This filtering removes contours where the radius is too large, or where the area within the contour is too large.
8) Integrate sensor log. In this step, a time-stamped sensor log with PLT data such as depth and temperature is integrated with the image contours. For example, the time-stamped sensor log containing PLT depth, temperature, pressure and internal state information per image slice is read and integrated with image contours.
9) Save contours to a CSV file. The image's contours can be saved to a CSV file for the image slice. Each row in the CSV file can be a contour and, presumably, a target of interest (e.g., particulate).
10) Aggregate CSV files for all images. In this step, each image's CSV contour file can be concatenated to create a single large CSV file. Columns in the file indicate the image slice, water depth, and other device sensor data for each contour found.

The workflow described in above steps 1) to 10) can be fully parameterized, allowing for adjustments to suit specific needs, such as altering contour filter thresholds to retain larger features. For example, increasing the thresholds of the contouring filter allows the retention of larger features such as kelp. After the creation of the tabulated CSV file, the PLT data can then be visualized and further analyzed using commercial or open-source software (e.g., for the creation of secondary statistics as in the nearest neighbor analysis).

### Testing and Field Deployment

The present technology has been tested in laboratory conditions. For example, PLT 100 has been tested in a 1500 L laboratory tank, within the large 8 meter deep Kelp Tank at the Stephen Birch Aquarium of Scripps Institution of Oceanography (SIO), in deployments off the SIO pier, and from both small watercraft and the R/V Beyster in the coastal waters off San Diego. In the laboratory tank, coastal water was mixed with varying density and size of potential particulate targets (including plankton and biological fragments collected from the nearshore, brine shrimp in various life history stages, polystyrene microspheres, and terrigenous dust and sand particles).

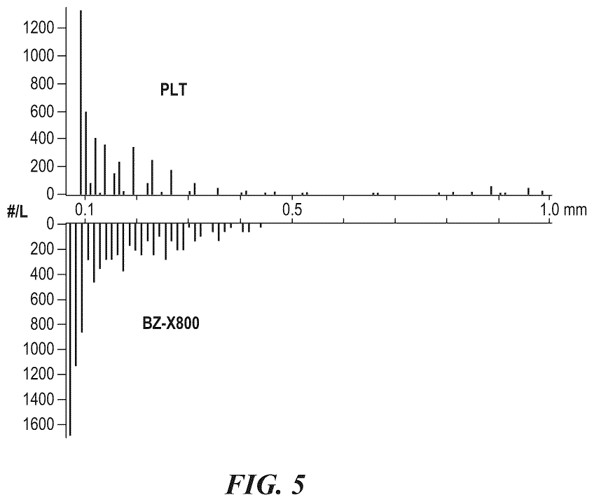

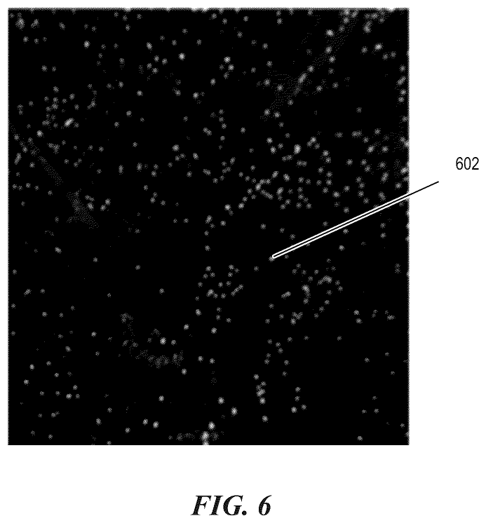

FIG. 5 shows a PLT estimation of suspended particulates (equivalent spherical diameter) in a 1500 L test tank (top) and a manual count of suspended particulates measured using an automated fluorescence microscope from a water aliquot (bottom), in accordance with various embodiments of the present technology. In this example, tank water aliquots were manually analyzed for particle size frequency distribution using an automated fluorescence microscope (Keyence BZ-X800) and Keyence image analysis software. These manual density estimates were compared to estimates obtained from the PLT suspended within the test tank showing similar particle counts. Here, the histogram bin sizes are not equal and PLT bins are quantized with pixel dimension. In addition, the microscope counts are in 10 μm bins and extend beyond the resolution of the PLT optics and do not include the large particles imaged by the PLT 100. Further, in order to repeatedly verify image focus, as well as the position and variation in laser sheet illumination across the PLT image slice, reusable ‘volumetric targets’ with a fixed distribution of particles of known size and position were used. These targets (3 cm thick and 20 cm square) were cast from transparent acrylic resin, with embedded polystyrene microspheres, and the microsphere distribution digitized after the resin had cured, as shown in FIG. 6. FIG. 6 shows a section of a cast volumetric test target illuminated by a PLT light sheet. Suspended in the test tank, the transparent volumetric targets were illuminated by the PLT laser sheet and easily movable to test and calibrate the optical performance of the system. In this example, dots included in FIG. 6 represent polystyrene microspheres having a diameter ranging from 100 μm and 500 μm.

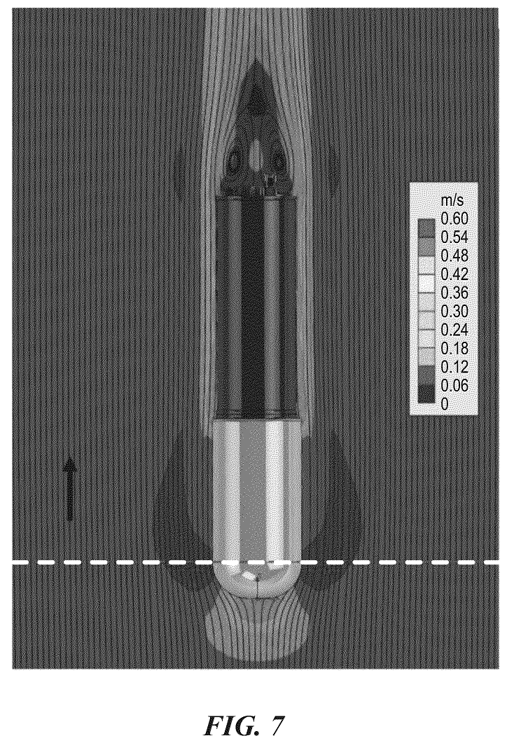

In some implementations, the PLT 100 can be designed to be deployed and attached to the end of a lowered line, fixed alongside an oceanographic sensor package, or attached to a stationary mooring. Because the PLT imaging plane projects perpendicularly from its housing and the particles imaged can be influenced by fluid flow around the instrument, it is important that the PLT 100 is positioned in unobstructed flow or near the leading edge of a moving body. The streamlined shape of the PLT helps reduce fluid turbulence in the imaging volume. FIG. 7 shows a simulation of flow velocities and streamlines around the PLT moving at a moderate cast speed (e.g., 0.5 m/s) using the computational fluid dynamics module within the SolidWorks engineering software package (e.g., Dassault Systems 2022). The flow around the instrument remains relatively laminar within mm of the optical window sidewall and as expected, forms low velocity eddies in its wake.

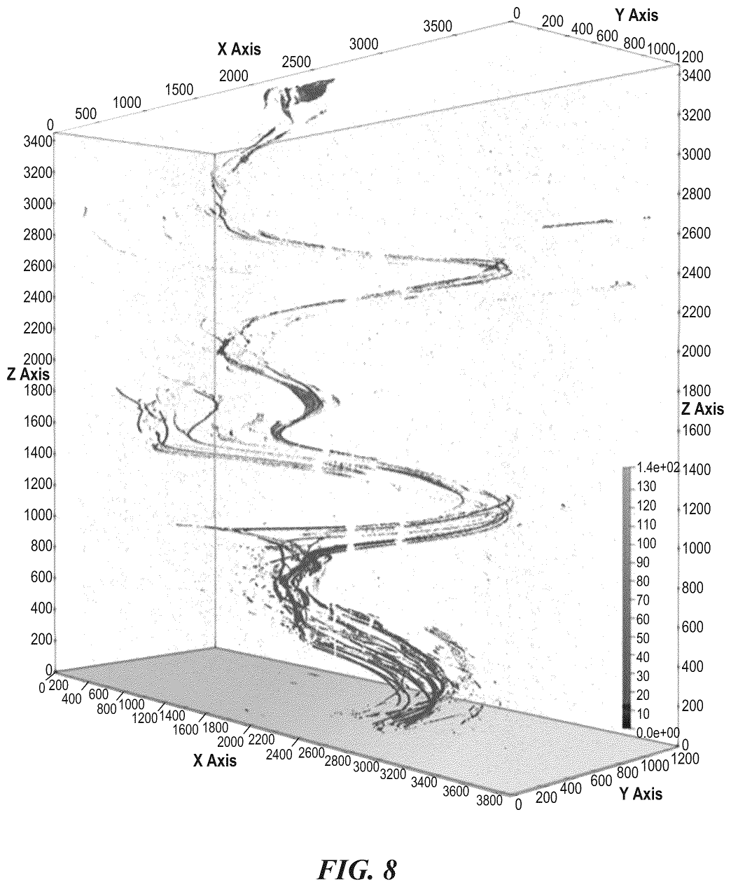

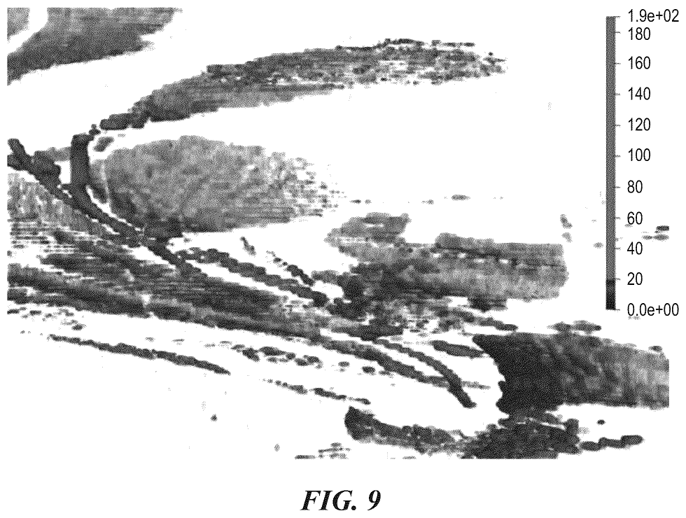

The present technology has also been tested in aquarium. For example, FIG. 8 shows a 3D reconstruction from PLT data through one section of the kelp tank exhibit at the Birch Aquarium at SIO. In this example, the PLT 100 was lowered by hand, and image data was recorded at 30 Hz. The central swirling rings are blades and stipes of Macrocystis kelp swaying within the tank as the PLT 100 moved past. The surrounding haze shows suspended particulate. A close up of the kelp blade detail is shown reconstructed from a side view in FIG. 9. The dramatic zig-zag profile shown in FIG. 8 is a side-effect of kelp and instrument movement caused by the tank's wave generator. In this example, the kelp is about 6 meter tall, and the axis extends at about a 50 cm radius. Here, the contrast indicates the intensity of backscattered laser light and individual particles are visible as the haze of small dark color dots. In comparison to the 3D rendering of FIG. 8, the close-up of FIG. 9 shows portion of the 3D model from the Birch Aquarium kelp forest tank, focusing on kelp stipes, fronds, and pneumatocysts.

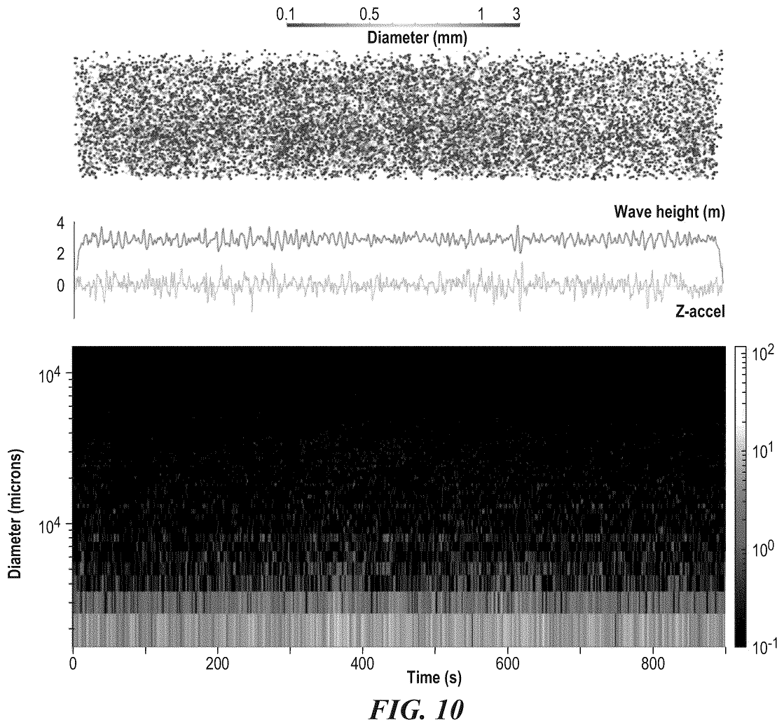

The present technology has been also tested in fixed mooring. For example, FIG. 10 shows a PLT data excerpt sampling at 0.5 Hz from a stationary deployment at 8 meter depth in the well-mixed water approximately 100 meter west of the breaking surf zone off the SIO pier. In the top panel, the well mixed and small size dominated particulate (equal to or less than 200 μm diameter) is evident, as it is in the number-size spectrogram in the bottom panel. The central panel illustrates some coincident PLT sensor metrics during the time series, including wave height (e.g., calculated from the PLT pressure sensor) and the Z-axis acceleration (relative to 1 g). The uniformity of the water column particulate size spectrum is expected in the turbulent and stirred water adjacent to the breaking surf zone with a 3 meter swell. It should be noted that because the PLT 100 uses a relatively large plexiglass imaging port it is susceptible to biofouling and any long-term deployment will require some mechanism for biofouling mitigation.

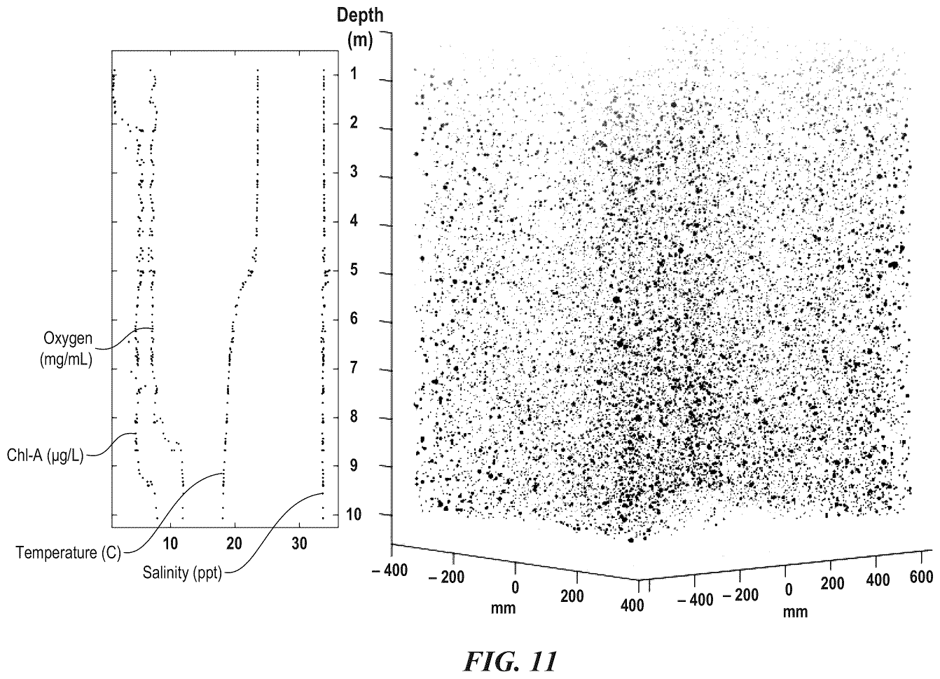

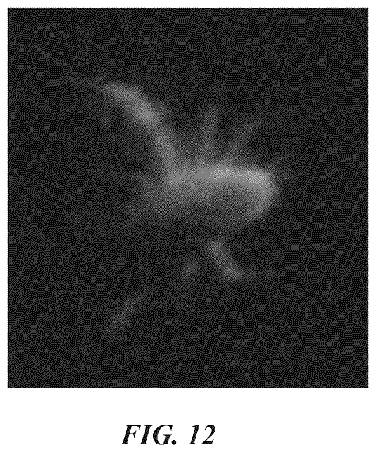

In some other examples, the PLT 100 has been tested in open ocean. For example, a higher sampling rate (30 Hz) data reconstruction in well-mixed surface waters off-shore the SIO pier to 10 m depth is shown in FIG. 11. The right panel of FIG. 11 illustrates the distribution of suspended particles within the 3D volume traversed by the PLT 100. In this example, the number of particles illustrated has been decimated by a factor of 25 to differentiate the particles in the plot and allow the data to be visualized (the total number of counted particles is larger than 106). The rendered dot size represents the equivalent spherical radius of particulate and varies with the size of the particle (scaled by a factor of 5) from 102 μm to 104 μm. As shown, a color gradient (yellow near surface to violet at 10 m) has been added to aid visualization. The left panel of FIG. 11 shows coincident sensor data collected from the PLT 100 mounted alongside a typical CTD (e.g., Seabird SBE-19, SBE-43 oxygen sensor, ECO Fluorometer) illustrating Chl-A (μg/l), oxygen concentration (mg/ml), salinity (ppt) and temperature (C) vs depth (m). Although large targets are usually excluded during image processing through contour filtering, incidental targets can be preserved and may be identified. An example image of a pelagic red crab, Pleuroncodes planipes, captured fortuitously by the PLT imaging is shown in FIG. 12.

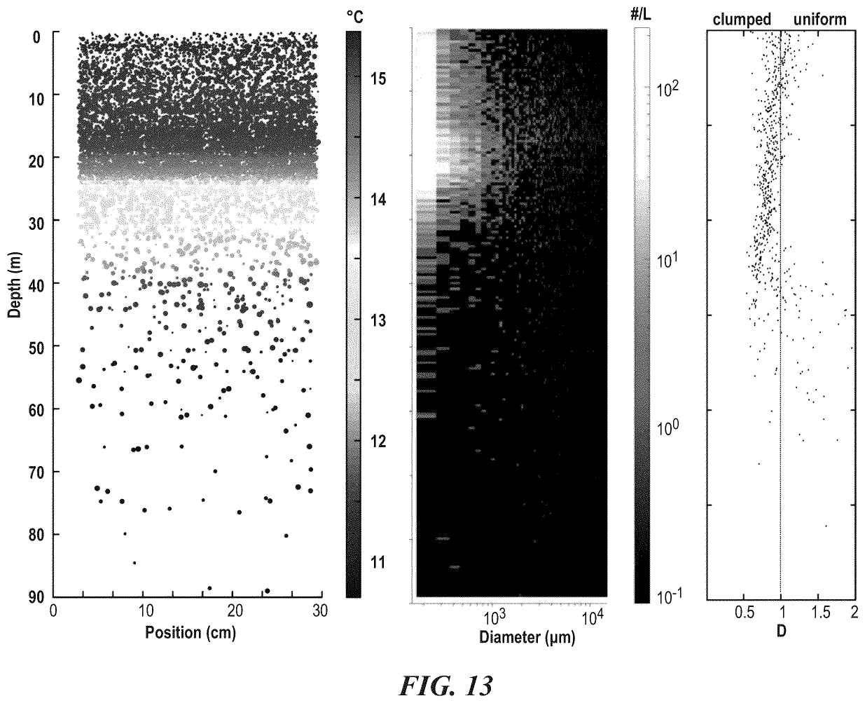

In some other examples, the PLT 100 has been tested in deep water. For example, FIG. 13 shows particle density data, particle number concentration size spectrogram and nearest neighbor statistical analysis data rendered from 90 meter depth cast offshore San Diego from the R/V Beyster using the PLT 100. The left panel of FIG. 13 illustrates the particulate density variation with depth and temperature. The increasing concentration of suspended particles through the thermocline is evident. The number of particles visualized has been decimated (plotting all data creates an illegible figure) and particles plotted as their scaled equivalent spherical radius. The cartesian plotting of the particle data in this view is a result of ‘unwrapping’ the raw PLT coordinate data from the original toroidal image and plotting them as a radial position from the central axis vs the depth of the sample image slice. The center panel of FIG. 13 shows the number concentration spectrogram emphasizing the dominance of small particles less than 1 mm above and within the thermocline. The right panel of FIG. 13 shows a secondary spatial statistic, D for nearest neighbor ratio analysis, calculated from PLT data which describes the degree of particle patchiness vs depth in each tomographic slice. The dimensionless ratio less than 1 indicates clumping in particle distributions and the dimensionless ratio larger than 1 suggests more uniform spatial distributions. Open ocean testing has validated the utility of the PLT 100 as a tool for examining the dynamics of particle distributions in a more complex oceanographic setting.

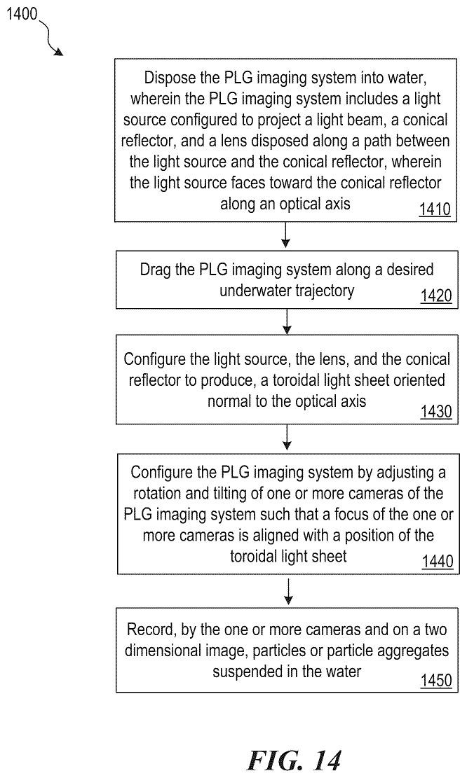

FIG. 14 is a flow chart illustrating a method 1400 of operating a tomographic imaging system in accordance with various embodiments of the present technology. The method 1400 includes disposing the PLG imaging system into water, wherein the PLG imaging system includes a light source configured to project a light beam, a conical reflector, and a lens disposed along a path between the light source and the conical reflector, wherein the light source faces toward the conical reflector along an optical axis, at 1410. For example, the lighting module components of the PLT 100 including the light source 120, the light sheet optics 122, as well as the imaging module components of the PLT 100 including camera 108, the image intensifier, and the objective lens 114 can be configured, before the deployment of the PLT 100. In particular, the camera 108 and the objective lens 114 can rotate and tilt such that its focus is coincident with a position of the light sheet124, which is controlled by the setting of the light source 120 and the light sheet optics 122, as described in FIG. 1.

The method 1400 also includes disposing the tomographic imaging system into water and dragging the tomographic imaging system along a desired underwater trajectory, at 1420. For example, as described in FIG. 4, the PLT 100 can be mounted on the support cage 402. The support cage 402 can act as a protective framework that can be lowered into the water at a predetermined depth to assist the operation of the PLT 100.

In addition, the method 1400 includes configuring the light source, the lens, and the conical reflector to produce, a toroidal light sheet oriented normal to the optical axis, at 1430. For example, the PLT 100 can be configured to generate the light sheet 124, which is a thin plane of light that is perpendicular to the optical axis of the laser source 120 and the light sheet optics 122. The optical axis can be adjusted by configuring the light reflection or scattering at the light sheet optics 122.

Moreover, the method 1400 includes configuring the PLG imaging system by adjusting a rotation and tilting of one or more cameras of the PLG imaging system such that a focus of the one or more cameras is aligned with a position of the toroidal light sheet, at 1440. For example, the focal length of the camera 108 of PLT 100 can be aligned to the light sheet 124, as shown in FIG. 1.

Lastly, the method 1400 includes recording, by one or more cameras of the imaging module and on a two dimensional image, particles or particle aggregates suspended in the water, at 1450. For example, the image sensor/camera 108, as a high-speed digital camera, can record the images of the light sheet 124 and the objects within it, as described in FIG. 1. The recorded tomographic image slices can be further processed to generate 3D distributions of particles or particle aggregates in the water.

The PLT described in this disclosure is a unique tool tailored for scientists to analyze the movement and distribution of suspended particulate matter in aquatic environments. This device stands out from other instruments that focus on detailed imaging and identification of individual plankton by offering a compact and lightweight solution capable of estimating particle size distribution across extensive volumes of water. The PLT's design is optimized for seamless autonomous integration with Conductivity, Temperature, and Depth instruments, as well as for high-frequency sampling during short-term moored deployments. Its ultralow power consumption feature, embodied in the UVP6-LP model, facilitates prolonged deployment periods, making it an ideal companion for remote systems such as Argo floats and other profiling floats. Together, the PLT of the present technology will allow researchers to develop new classes of scientific questions around the flux of particulates among water masses, particle vertical distributions and stratification in lakes, rivers, coastal and open ocean settings, and particle export and export carbon flux, all with a spatial and temporal resolution not previously possible.

It is understood that the various disclosed embodiments may be implemented individually, or collectively, using devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

Only a few implementations and examples are described and other implementations, enhancements and variations can be made based on what is described and illustrated in this patent document.

What is claimed is:

1. A pelagic laser tomographic (PLG) imaging system, comprising:
a pressure housing extending along a longitudinal axis and having a first end and a second end disposed along the longitudinal axis;
an end cap disposed on the first end of the pressure housing;
a cylinder disposed on the second end of the pressure housing;
one or more cameras disposed in the pressure housing and oriented towards the cylinder;
a light source disposed in the cylinder, the light source configured to project a light beam;
a conical reflector disposed close to one end of the cylinder and away from the one or more cameras, wherein the light source faces toward the conical reflector along an optical axis; and
a lens disposed along a path between the light source and the conical reflector, wherein the light source, the lens, and the conical reflector are configured to generate a toroidal light sheet oriented normal to the optical axis,
wherein the one or more cameras are capable of being rotated and tilted such that a focus of the one or more cameras is coincident with a position of the toroidal light sheet.

2. The PLG imaging system of claim 1, wherein the toroidal light sheet surrounds the cylinder and has a thickness up to 10 mm.

3. The PLG imaging system of claim 1, wherein the light source is a 532 nm laser diode module configured to project a gaussian beam through the lens.

4. The PLG imaging system of claim 1, wherein the pressure housing is made of materials comprising aluminum, titanium, stainless steel, polycarbonate, acrylic, polyethylene, or a combination thereof.

5. The PLG imaging system of claim 1, wherein the cylinder is transparent and made of polymethyl methacrylate (PMMA).

6. The PLG imaging system of claim 1, further comprising one or more image sensors and one or more image processors, wherein the one or more image sensors and the one or more image processors are disposed in the pressure housing and connected to the one or more cameras.

7. The PLG imaging system of claim 6, further comprising an image intensifier disposed in the pressure housing, wherein the image intensifier is disposed between and coupled to the one or more cameras and the one or more image sensors, and the image intensifier includes one or more lens and one or more light bandpass filters.

8. The PLG imaging system of claim 7, wherein the one or more light bandpass filters comprises a 532 nm narrow bandpass filter.

9. The PLG imaging system of claim 7, wherein the image intensifier is coupled to the one or more cameras through a relay lens doublet.

10. The PLG imaging system of claim 1, further comprising one or more image shutters, wherein the one or more image shutters are coupled with the one or more cameras and configured to synchronize operation of the one or more cameras with the light beam pulsed from the light source.

11. The PLG imaging system of claim 1, further comprising one or more measurement units, each measurement unit comprising a gyroscope, an accelerometer, a magnetometer, a pressure sensor, a time clock, or a temperature sensor.

12. The PLG imaging system of claim 1, comprising a battery disposed in the pressure housing, the battery being electrically connected to and providing power to the one or more cameras and the light source.

13. The PLG imaging system of claim 1, wherein the end cap is configured to seal the pressure housing using one or more O-rings.

14. The PLG imaging system of claim 1, further comprising one or more mirrors disposed on an optical path of the light beam and within the cylinder.

15. A pelagic laser tomographic (PLG) instrument, comprising:
a lighting module comprising a light source and a conical reflector, wherein the lighting module generates a toroidal light sheet that surrounds the PLG instrument and that is oriented normal to an optical axis between the light source and the conical reflector;
an imaging module comprising one or more cameras, the one or more cameras being rotated and tilted such that its focus is coincident with a position of the toroidal light sheet; and
a processor and a memory with instructions stored thereon, wherein the instruction upon execution by the processor cause the processor to receive information representative of signals captured by the one or more cameras of the imaging module,
wherein the lighting module and the imaging module are disposed in a closed shell of the PLG instrument.

16. A method of operating a pelagic laser tomographic (PLG) imaging system, comprising:
disposing the PLG imaging system into water, wherein the PLG imaging system includes a light source configured to project a light beam, a conical reflector, and a lens disposed along a path between the light source and the conical reflector, wherein the light source faces toward the conical reflector along an optical axis;
dragging the PLG imaging system along a desired underwater trajectory;
configuring the light source, the lens, and the conical reflector to produce, a toroidal light sheet oriented normal to the optical axis;
configuring the PLG imaging system by adjusting a rotation and tilting of one or more cameras of the PLG imaging system such that a focus of the one or more cameras is aligned with a position of the toroidal light sheet; and
recording, by the one or more cameras and on a two dimensional image, particles or particle aggregates suspended in the water.

17. The method of claim 16, further comprising repeating generating of the toroidal light sheet and recording of the two dimensional image, to generate a three dimensional model that comprises spatially contiguous slices of the two dimensional images.

18. The method of claim 17, further comprising:
converting the slices of the two dimensional images into grayscale through eliminating red and blue channel information and shading green channel information therein;
applying a median filter to remove potential noise from the converted grayscale slices of the two dimensional images;
adaptively thresholding to map the converted grayscale slices of the two dimensional images by using a value based upon a mean of a set of nearby values within a window around a pixel;
masking the grayscale slices of the two dimensional images to remove portions of the grayscale slices of the two dimensional images that do not contain date or have potentially problematic data; and
contouring to identify bright regions surrounding the grayscale slices of the two dimensional images by dark pixels.

19. The method of claim 18, further comprising filtering the set of contours to remove outliers contours and integrating time-stamped sensor log containing PLT depth, temperature, pressure and internal state information.

20. The method of claim 19, further comprising adjusting thresholds of the contouring filter for retention of a variety of contour features.
